(19) United States
(12) Patent Application Publication
(10) Pub. No.: US 2009/0319708 A1
(43) Pub. Date: Dec. 24, 2009

(54) ELECTRONIC SYSTEM AND RELATED METHOD WITH TIME-SHARING BUS

(76) Inventors: Yu-Ping Ho, Kao-Hsiung Hsien (TW); Jui-Hsing Tseng, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/141,917

(22) Filed: Jun. 19, 2008

(51) Int. Cl. G06F 13/36; G06F 12/00; G06F 1/12

(52) U.S. Cl. 710/113; 711/105; 710/61; 711/103; 711/E12.083; 711/E12.008

(57) ABSTRACT

An electronic system with time-sharing bus includes a controller, a storage element, a first electronic element, and a shared bus. The controller receives a command to generate a set of enable signals and a set of operation signals. The storage element has a first set of input ends coupled to the controller for receiving a first enable signal of the set of enable signals. The first electronic element has a first input end coupled to the controller for receiving a second enable signal of the set of enable signals. The shared bus is coupled between the controller and the storage element, and is coupled between the controller and the first electronic element. The shared bus provides the set of operation signals to the storage element while the first electronic element is disabled and provides the set of operation signals to the first electronic element while the storage element is disabled.

### BACKGROUND

The present disclosure is related to an electronic system and related method with a time-sharing bus, and more particularly, to an electronic system and related method utilizing a set of enable signals and a set of operation signals to control a storage element and other electronic elements for sharing a bus of the electronic system.

Memory is an important element found in many types of electronic devices. With recent rapid technological improvements, an increased number of DRAMs are now supplied as a common memory type of electronic devices. There are several kinds of DRAMs currently available on the market. For example, a synchronous DRAM (also referred to as SDRAM) is a kind of DRAM that can be continuously written to and read from at high speeds synchronized with the clock of the interface (the read/write process is also referred to as a burst transfer). A double data rate SDRAM (also referred to as DDR SDRAM) is a kind of DRAM that has a doubled burst transfer speed by executing the burst transfer of the SDRAM in synchronism with both the leading edge and the trailing edge of the clock signal. Since SDRAMs constitute an inexpensive and large-capacity memory source, their usage is becoming more commonly employed in electronic devices.

Please refer to FIG. 1. FIG. 1 is a block diagram of a storage element 100 in the prior art. The storage element 100 is a high-speed CMOS synchronous DRAM containing 64 Mbits. It is internally configured as 4 Banks of 1M word×16 DRAM with a synchronous interface. The storage element 100 includes a clock buffer 110, a command decoder 120, a control signal generator 130, an address buffer 140, a column counter 150, a refresh counter 160, a mode register 170, a buffer 180, and four banks BANK0-BANK3, whereof each bank BANK0-BANK3 includes a cell array containing a size of 1M×16.

As shown in FIG. 1, the clock buffer 110 is used for controlling a clock signal CLK, whereof all input signals of the storage element 100 are sampled on a positive edge of the clock signal CLK. The command decoder 120 is used for decoding commands to generate corresponding control signals, and then the control signal generator outputs the corresponding control signals to a control bus CTL_BUS. For example, a clock enable signal CKE is used for activating (HIGH) and deactivating (LOW) the clock signal CLK. A chip select signal CS_L enables (sampled LOW) and disables (sampled HIGH) the command decoder 120, whereof all commands are masked when the chip select signal CS_L is sampled HIGH. The chip select signal CS_L also provides for external bank selection on systems with multiple banks. A row address strobe signal RAS_L defines the operation commands in conjunction with a column address strobe signal CAS_L and a write enable signal WE_L. Data input/output mask signals LDQM and UDQM are used for masking input data in write mode. Bank select signals BA0-BA1 are used for selecting the bank for operation and address input signals A0-A11 are used for selecting one location in the respective bank. The address buffer 140 outputs the address to an address bus ADD_BUS. Data signals DQ0-DQ15 are stored in the buffer 180 and then transmitted to a data bus DTA_BUS.

The tendency of chip integration continues to head towards more logic components and smaller areas. At present, a chip designer desires to lessen pins for lowering cost and reducing the areas of the circuit as far as possible. However, the storage element 100, such as a synchronous DRAM, always occupies quite a lot of pins. The drawbacks are that it wastes large area and raises the cost, which is not economical to manufacture.

### SUMMARY OF THE DISCLOSURE

It is an objective of the claimed disclosure to provide an electronic system with time-sharing bus.

According to an embodiment of the present disclosure, an electronic system with time-sharing bus is provided. The electronic system includes a controller, a storage element, a first electronic element, and a shared bus. The controller is used for receiving a command to generate a set of enable signals and a set of operation signals. The storage element has a first set of input ends coupled to the controller for receiving a first enable signal of the set of enable signals. The first electronic element has a first input end coupled to the controller for receiving a second enable signal of the set of enable signals. The shared bus is coupled between the controller and the storage element, and is coupled between the controller and the first electronic element. The shared bus provides the set of operation signals to the storage element while the first electronic element is disabled and the shared bus provides the set of operation signals to the first electronic element while the storage element is disabled. The electronic system may further include a second electronic element having a first input end coupled to the controller for receiving a third enable signal of the set of enable signals.

It is an objective of the claimed disclosure to provide a method for sharing a bus of an electronic system.

According to an embodiment of the present disclosure, a method for sharing a bus of an electronic system is provided. The method includes receiving a command to generate a set of enable signals and a set of operation signals, controlling a storage element according to a first enable signal of the set of enable signals, controlling a first electronic element according to a second enable signal of the set of enable signals, and providing a shared bus for transmission of the set of operation signals to the first electronic element while the storage element is disabled. The method further includes providing the sharing bus for transmission of the set of operations signals to the storage element while the first electronic element is disabled.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a storage element in the prior art.

FIG. 2 is a table illustrating relationships between operation modes and control signals in a memory.

FIG. 3 is a diagram of an electronic system with a time-sharing bus according to a first embodiment of the present disclosure.

FIG. 4 is a timing diagram illustrating the operations of the electronic system in FIG. 3.

FIG. 5 is a diagram of an electronic system with a time-sharing bus according to a second embodiment of the present disclosure.

FIG. 6 is a timing diagram illustrating the operations of the electronic system in FIG. 5.

FIG. 7 is a diagram of an electronic system with a time-sharing bus according to a third embodiment of the present disclosure.

FIG. 8 is a timing diagram illustrating the operations of the electronic system in FIG. 7.

FIG. 9 is a diagram of an electronic system 900 with a time-sharing bus according to a fourth embodiment of the present disclosure.

FIG. 10 is a timing diagram illustrating the operations of the electronic system in FIG. 9.

FIG. 11 is a diagram of an electronic system with time-sharing bus according to a fifth embodiment of the present disclosure.

FIG. 12 is a flow illustrating a method for sharing a bus of an electronic system according to an embodiment of the present disclosure.

FIG. 13 is a flow illustrating a method for sharing a bus of an electronic system according to another embodiment of the present disclosure.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

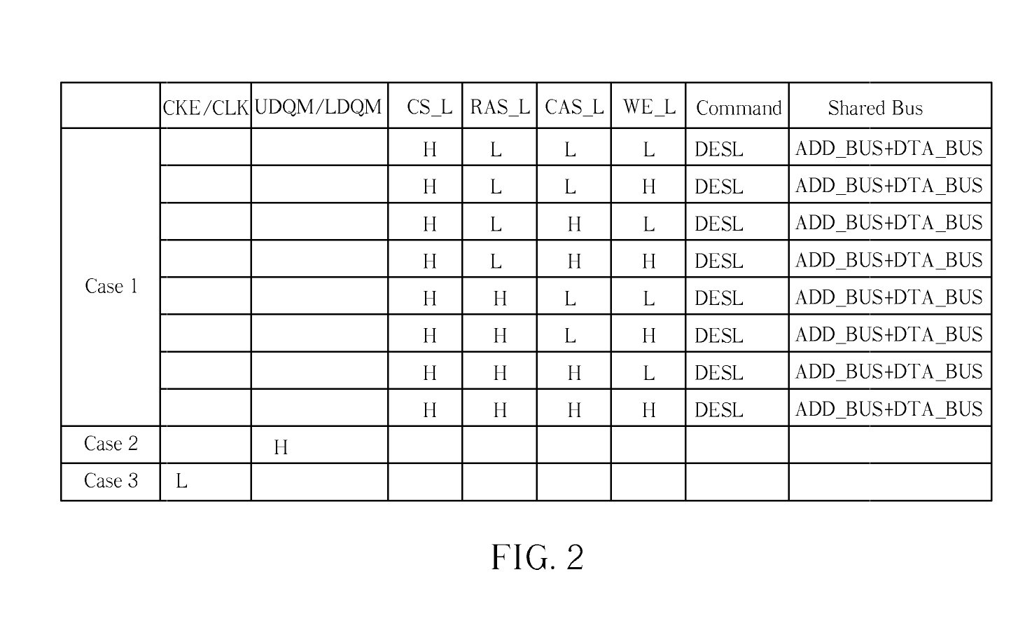

Please refer to FIG. 2. FIG. 2 is a table illustrating relationships between operation modes and control signals in a memory. As shown in FIG. 2, the operation modes are divided into three conditions Case 1-Case 3.

In Case 1, the chip select signal CS_L is HIGH and other control signals, such as RAS_L, CAS_L, and WE_L are not considered. In this condition, the chip select signal CS_L disables the command decoder 120 and all commands are masked. At this time, the address bus ADD_BUS and data bus DTA_BUS are not utilized.

In Case 2, the data input/output mask signals LDQM and UDQM are HIGH and other control signals are not considered. In this condition, the data input/output mask signals LDQM and UDQM mask input data. Hence, the address bus ADD_BUS and data bus DTA_BUS are free.

In Case 3, the clock signal CLK (or the clock enable signal CKE) is LOW and other control signals are not considered. In this condition, the whole memory does not work. For this reason, the address bus ADD_BUS and data bus DTA_BUS are free at this time. Due to the address bus ADD_BUS and data bus DTA_BUS of the memory being free during certain periods, other electronic devices may share the buses during these times.

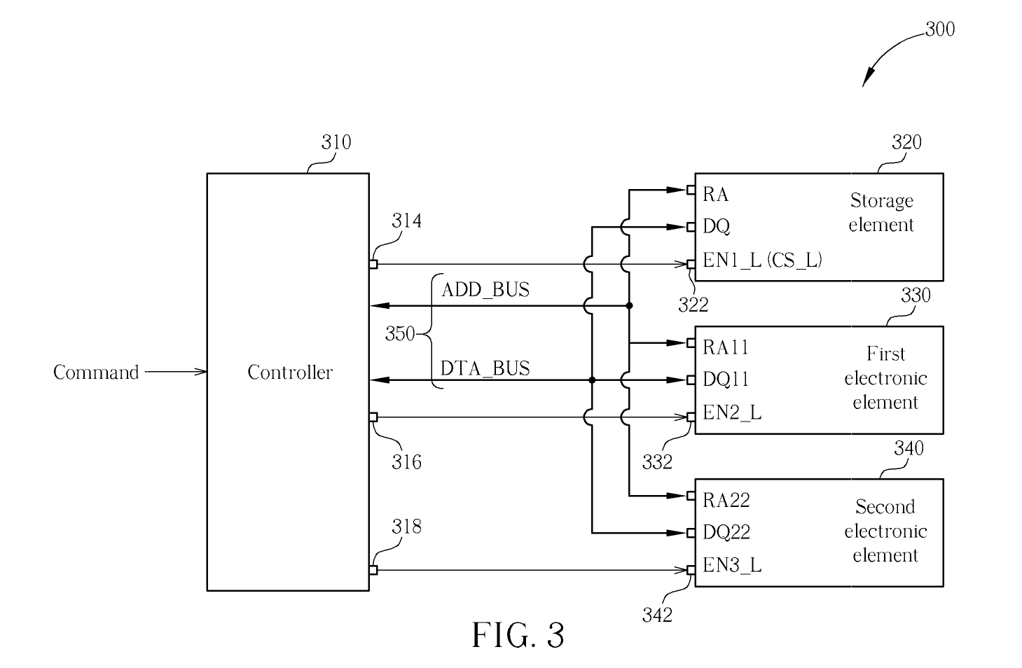

Please refer to FIG. 3, which is a diagram of an electronic system 300 with time-sharing bus according to a first embodiment of the present disclosure. The electronic system 300 includes a controller 310, a storage element 320, a first electronic element 330, a second electronic element 340, and a shared bus 350. The controller 310 receives a command to generate a set of enable signals and a set of operation signals. The storage element 320 has a first input end 322 coupled to a first output end 314 of the controller 310 for receiving a first enable signal EN1_L of the set of enable signals. In this embodiment, the first enable signal EN1_L of the set of enable signals is the abovementioned chip select signal CS_L. The first electronic element 330 has a first input end 332 coupled to a second output end 316 of the controller 310 for receiving a second enable signal EN2_L of the set of enable signals. The second electronic element 340 has a first input end 342 coupled to the third output end 318 of the controller 310 for receiving a third enable signal EN3_L of the set of enable signals.

Please continue to refer to FIG. 3. The shared bus 350 includes an address bus ADD_BUS and a data bus DTA_BUS. The address bus ADD_BUS is coupled between the controller 310 and an input end RA of the storage element 320, is coupled between the controller 310 and an input end RA11 of the first electronic element 330, and is coupled between the controller 310 and an input end RA22 of the second electronic element 340. The data bus DTA_BUS is coupled between the controller 310 and an input end DQ of the storage element 320, is coupled between the controller 310 and an input end DQ11 of the first electronic element 330, and is coupled between the controller 310 and an input end DQ22 of the second electronic element 340.

The shared bus 350 provides the set of operation signals to the storage element 320 when the controller 310 transmits an enable signal to the storage element 320 and does not transmit enable signals to the first electronic element 330 and the second electronic element 340, enabling the storage element 320 and disabling both the first electronic element 330 and the second electronic element 340. The shared bus 350 provides the set of operation signals to the first electronic element 330 when the controller 310 transmits an enable signal to the first electronic element 330 and does not transmit enable signals to the storage element 320 and the second electronic element 340. Similarly, the shared bus 350 provides the set of operation signals to the second electronic element 340 when the controller 310 transmits an enable signal to the second electronic element 340 and does not transmit enable signals to the storage element 320 and the first electronic element 330.

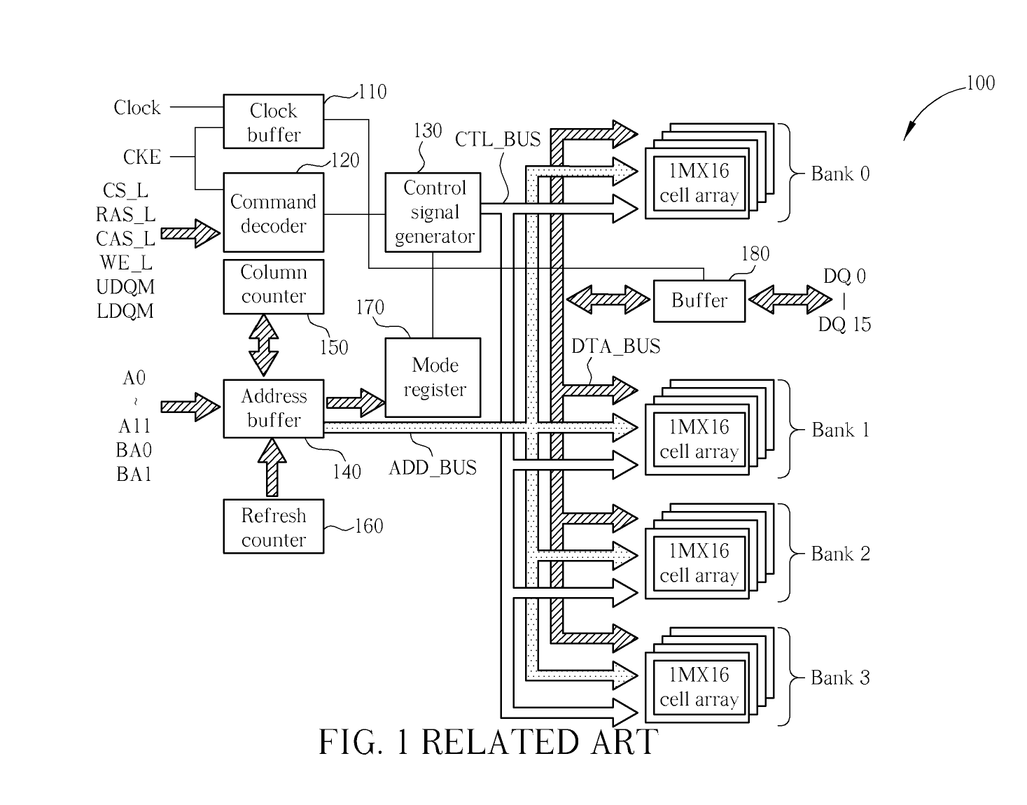

The storage element 320 is a DRAM, for example, as the storage element 100 mentioned in FIG. 1. The first electronic element 330 and the second electronic element 340 can be a flash, an ATA, a GPIO (General Purpose Input Output) device, or another device. In one embodiment, the electronic system 300 is an application specific integrated circuit (ASIC).

It should be noted that the electronic system 300 is not limited to share the shared bus 350 for the first electronic element 330 and the second electronic element 340 only, the shared bus 350 can be provided for any number of electronic elements, however only a single device on the receiving end of the shared bus is active at any given time due to the enable signals. Because the enable signals are preferably Boolean in nature, each enable signal can be a single bit. Furthermore, the storage element 320 is not limited to a DRAM only, and can be memory of other types.

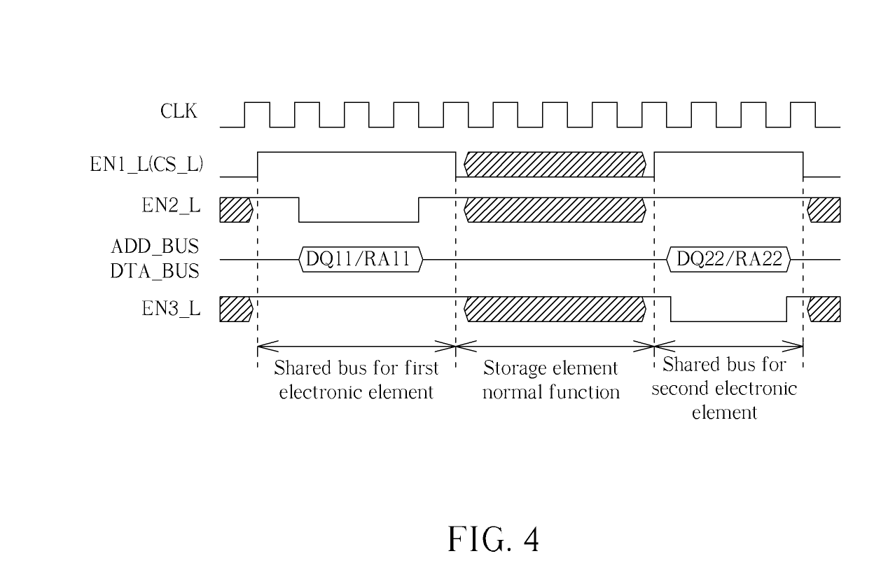

Please refer to FIG. 4, which is a timing diagram illustrating the operations of the electronic system 300 in FIG. 3. Please refer to FIG. 4 and FIG. 3 at the same time. As shown in FIG. 4, the first enable signal EN1_L (or the chip select signal CS_L) is HIGH in the beginning, which will disable the storage element 320. At this time, the second enable signal EN2_L is set to LOW, which indicates that the shared bus 350 will provide the set of operation signals (DQ11 and RA11) to the first electronic element 330. Afterwards, the first enable signal EN1_L is set to LOW, which will enable the storage element 320. At this time, the storage element 320 work normally and both the second enable signal EN2_L and the third enable signal EN3_L are set to HIGH. Finally, the first enable signal EN1_L is set to HIGH again. At this time, the third enable signal EN3_L is set to LOW, which indicates that the shared bus will provide the set of operation signals (DQ22 and RA22) to the second electronic element 340. The shared bus 350 is controlled through the settings of the first enable signal EN1_L, the second enable signal EN2_L, and the third enable signal EN3_L. Hence, the electronic system 300 is capable of reaching an objective of sharing buses.

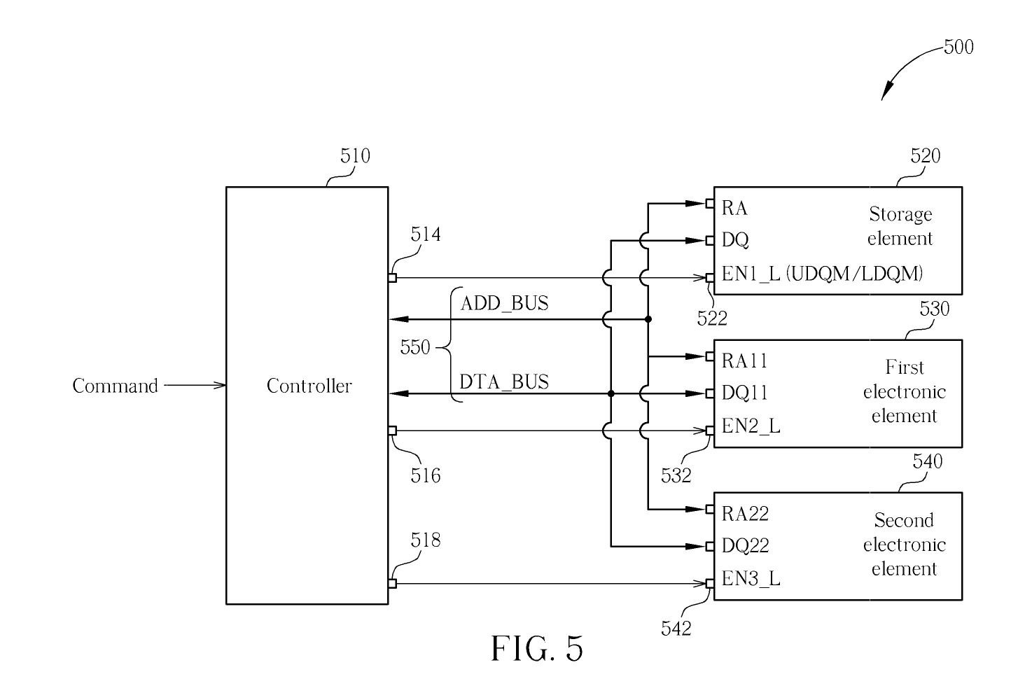

Please refer to FIG. 5, which is a diagram of an electronic system 500 with time-sharing bus according to a second embodiment of the present disclosure. The electronic system 500 includes a controller 510, a storage element 520, a first electronic element 530, a second electronic element 540, and a shared bus 550. Connection manners of the electronic system 500 are the same as connection manners of the electronic system 300 in FIG. 3, and are not described anymore. The differences between the second embodiment and the first embodiment can be described as follows. According to this embodiment, the first enable signal EN1_L of the set of enable signals is the abovementioned data input/output mask signals LDQM and UDQM, which are used for masking input data in write mode.

Please continue to refer to FIG. 5. The shared bus 550 includes an address bus ADD_BUS and a data bus DTA_BUS. The shared bus 550 provides the set of operation signals to the storage element 520 while both the first electronic element 530 and the second electronic element 540 are disabled, provides the set of operation signals to the first electronic element 530 while both the storage element 520 and the second electronic element 540 are disabled, and provides the set of operation signals to the second electronic element 540 while both the storage element 520 and the first electronic element 530 are disabled.

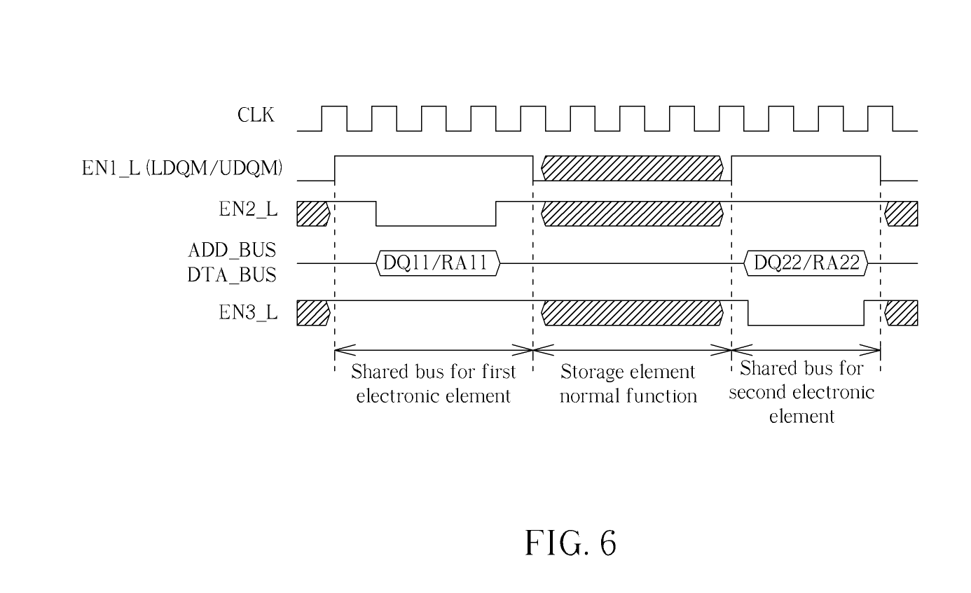

Please refer to FIG. 6 and FIG. 5. FIG. 6 is a timing diagram illustrating the operations of the electronic system 500 in FIG. 5. As shown in FIG. 6, the first enable signal EN1_L (or the data input/output mask signals LDQM and UDQM) is HIGH in the beginning, which will mask the input data of the storage element 320. At this time, the second enable signal EN2_L is set to LOW, which indicates that the shared bus 550 will provide the set of operation signals (DQ11 and RA11) to the first electronic element 530. Afterwards, the first enable signal EN1_L is set to LOW, which enables the data of the storage element 520 to output. At this time, the storage element 520 works normally and both the second enable signal EN2_L and the third enable signal EN3_L are set to HIGH. Finally, the first enable signal EN1_L is set to HIGH again. At this time, the third enable signal EN3_L is set to LOW, which indicates that the shared bus will provide the set of operation signals (DQ22 and RA22) to the second electronic element 540. The shared bus 550 is controlled through the settings of the first enable signal EN1_L, the second enable signal EN2_L, and the third enable signal EN3_L. Hence, the electronic system 500 is capable of reaching an objective of a shared bus.

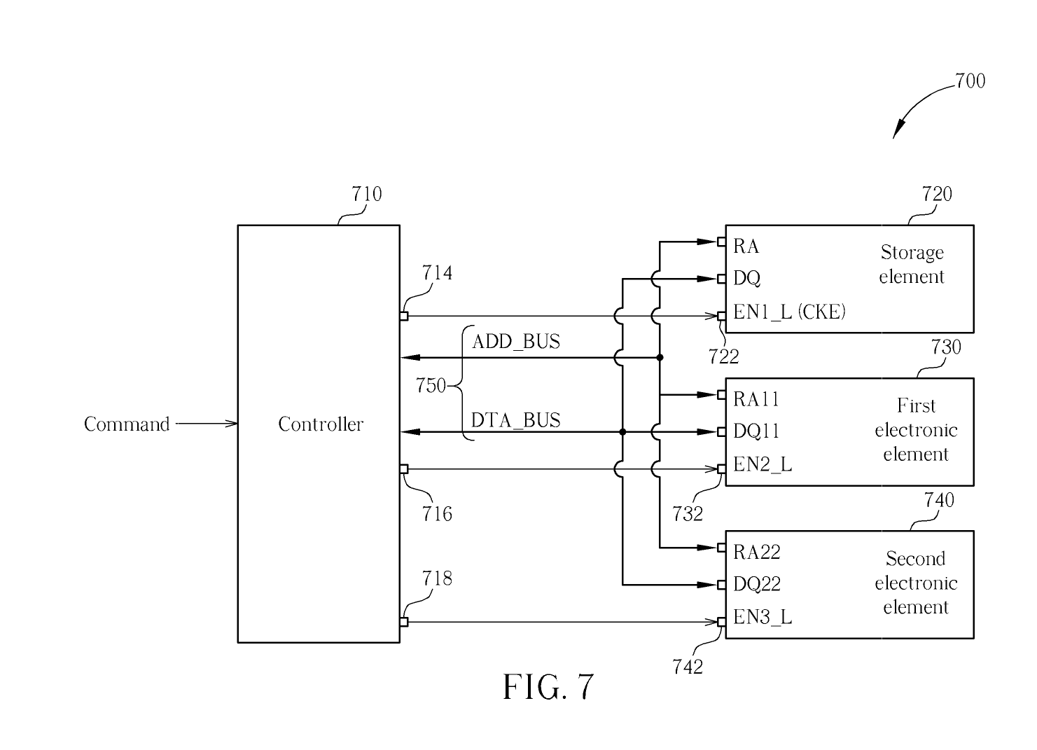

Please refer to FIG. 7, which is a diagram of an electronic system 700 with a time-sharing bus according to a third embodiment of the present disclosure. The electronic system 700 includes a controller 710, a storage element 720, a first electronic element 730, a second electronic element 740, and a shared bus 750. Connection manners of the electronic system 700 are the same as connection manners of the electronic system 300 in FIG. 3, and are not described anymore. The differences between the third embodiment and the first embodiment (or the second embodiment) can be described as follows. According to this embodiment, the first enable signal EN1_L of the set of enable signals is the abovementioned clock enable signal CKE, which is used for activating (HIGH) and deactivating (LOW) the clock signal CLK.

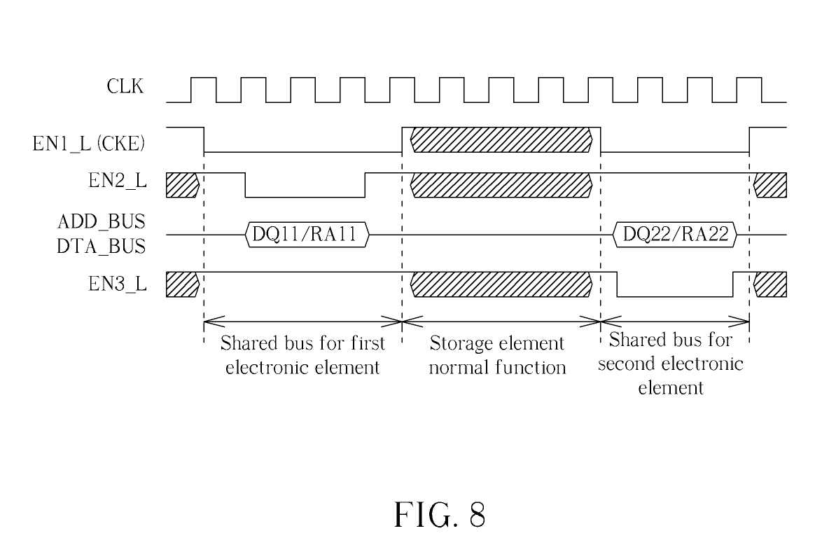

Please refer to FIG. 8 and FIG. 7. FIG. 8 is a timing diagram illustrating the operations of the electronic system 700 in FIG. 7. As shown in FIG. 8, the first enable signal EN1_L (or the clock enable signal CKE) is LOW in the beginning, which will deactivate the clock signal CLK of the storage element 720. At this time, the second enable signal EN2_L is set to LOW, which indicates that the shared bus 750 will provide the set of operation signals (DQ11 and RA11) to the first electronic element 730. Afterwards, the first enable signal EN1_L is set to HIGH, which activates the clock signal CLK. At this time, the storage element 720 works normally and both the second enable signal EN2_L and the third enable signal EN3_L are set to HIGH. Finally, the first enable signal EN1_L is set to LOW again. At this time, the third enable signal EN3_L is set to LOW, which indicates that the shared bus will provide the set of operation signals (DQ22 and RA22) to the second electronic element 740. The shared bus 750 is controlled through the settings of the first enable signal EN1_L, the second enable signal EN2_L, and the third enable signal EN3_L. Hence, the electronic system 700 is capable of reaching an objective of sharing buses.

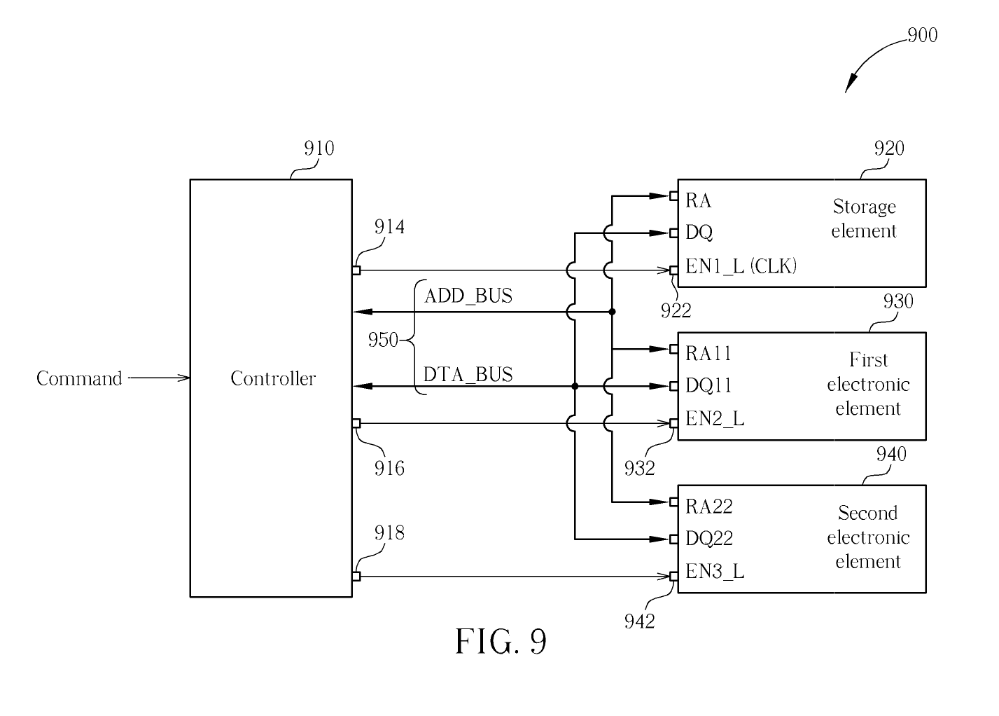

Please refer to FIG. 9, which is a diagram of an electronic system 900 with a time-sharing bus according to a fourth embodiment of the present disclosure. The electronic system 900 includes a controller 910, a storage element 920, a first electronic element 930, a second electronic element 940, and a shared bus 950. Connection manners of the electronic system 900 are the same as connection manners of the electronic system 300 in FIG. 3, and are not described anymore. The differences between the fourth embodiment and the first embodiment (or the second and the third embodiments) can be described as follows. According to this embodiment, the first enable signal EN1_L of the set of enable signals is the abovementioned clock signal CLK.

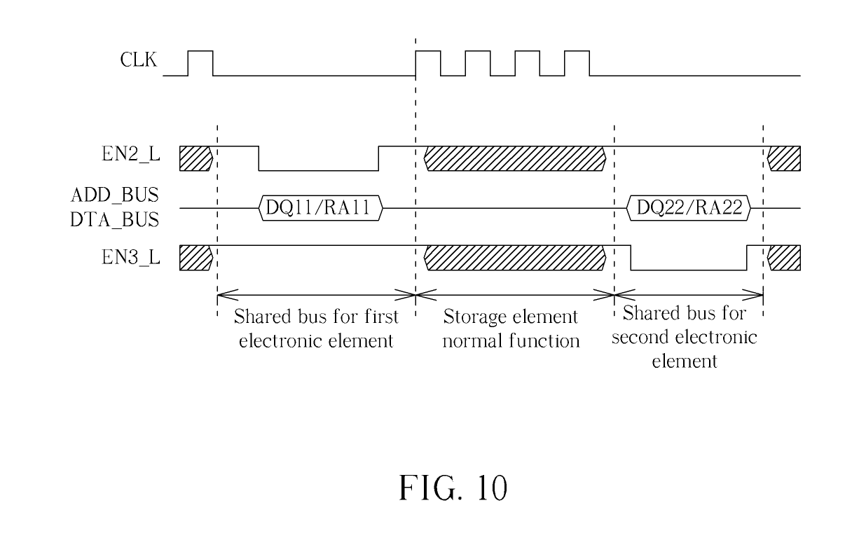

Please refer to FIG. 10 and FIG. 9. FIG. 10 is a timing diagram illustrating the operations of the electronic system 900 in FIG. 9. As shown in FIG. 10, the first enable signal EN1_L (or the clock signal CLK) does not work in the beginning, which indicates that the storage element 920 does not work. At this time, the second enable signal EN2_L is set to LOW, which indicates that the shared bus 950 will provide the set of operation signals (DQ11 and RA11) to the first electronic element 930. Afterwards, the first enable signal EN1_L (or the clock signal CLK) starts working. At this time, the storage element 920 work normally and both the second enable signal EN2_L and the third enable signal EN3_L are set to HIGH. Finally, the first enable signal EN1_L stops working again. At this time, the third enable signal EN3_L is set to LOW, which indicates that the shared bus 950 will provide the set of operation signals (DQ22 and RA22) to the second electronic element 940. The shared bus 950 is controlled through the settings of the first enable signal EN1_L, the second enable signal EN2_L, and the third enable signal EN3_L. Hence, the electronic system 900 is capable of reaching an objective of a shared bus.

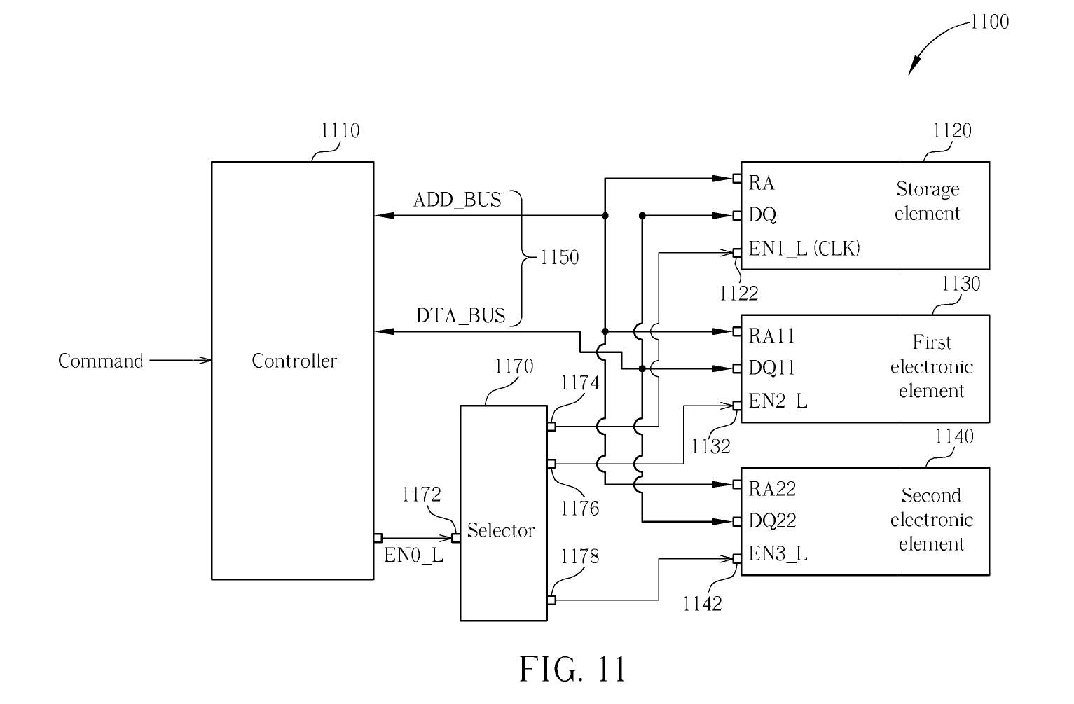

Please refer to FIG. 11, which is a diagram of an electronic system 1100 with time-sharing bus according to a fifth embodiment of the present disclosure. The electronic system 1100 includes a controller 1110, a storage element 1120, a first electronic element 1130, a second electronic element 1140, a shared bus 1150, and a selector 1170. Connection manners of the electronic system 1100 are similar to connection manners of the electronic system 300 in FIG. 3. The differences between the fifth embodiment and the first embodiment can be described as follows. According to this embodiment, the electronic system 1100 further includes the selector 1170 coupled between the controller 1110 and the storage element 1120, the first electronic 1130, and the second electronic element 1140. The selector 1170 has an input end 1172 for receiving an enable signal EN0_L, a first output end 1174 for outputting a first enable signal EN1_L to the storage element 1120, a second output end 1176 for outputting a second enable signal EN2_L to the first electronic element 1130, and a third output end 1178 for outputting a third enable signal EN3_L to the second electronic element 1140. The selector 1170 is used for selecting one device from the storage element 1120, the first electronic element 1130, and the second electronic element 1140. The shared bus 1150 is controlled through the settings of the first enable signal EN1_L, the second enable signal EN2_L, and the third enable signal EN3_L. Hence, the electronic system 1100 is capable of reaching an objective of sharing buses.

In one embodiment, the selector 1170 can be a multiplexer. Please note that the selector 1170 is an optional device. This is only an embodiment and is not to limit practical applications of the present disclosure.

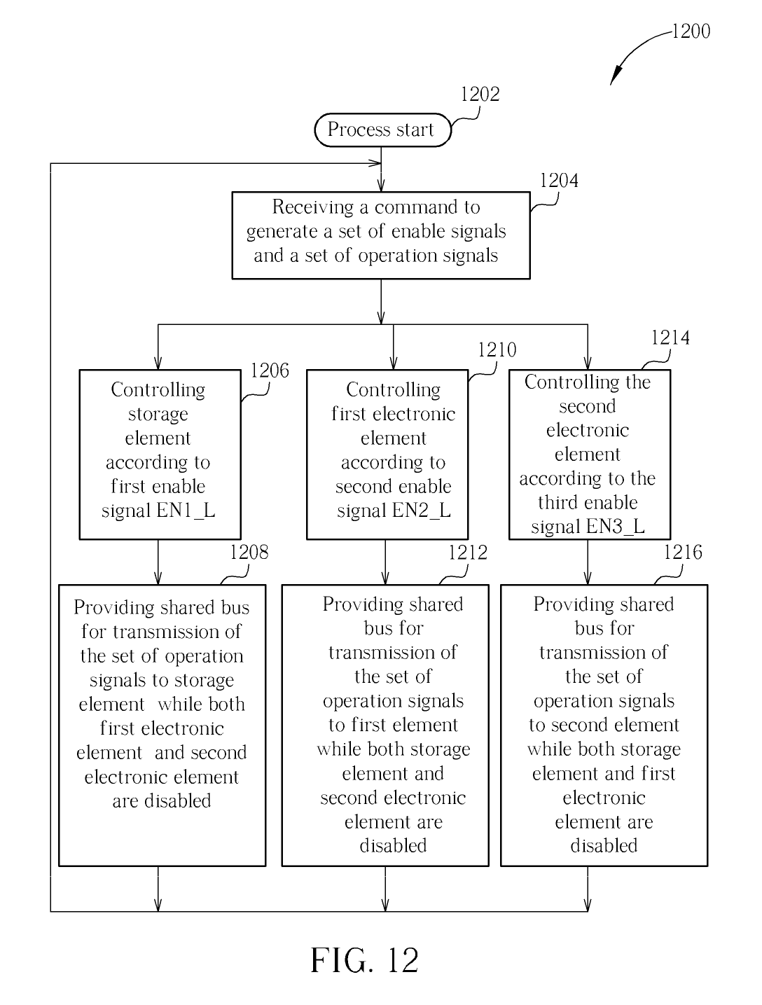

Please refer to FIG. 12, which is a flow 1200 illustrating a method for sharing a bus of an electronic system according to an embodiment of the present disclosure. The flow 1200 includes the following steps:
Step 1202: Process start.
Step 1204: Receive a command to generate a set of enable signals and a set of operation signals.
Step 1206: Control the storage element 320 according to the first enable signal EN1_L.
Step 1208: Provide the shared bus 350 for transmission of the set of operation signals to the storage element 320 while both the first electronic element 330 and the second electronic element 340 are disabled.
Step 1210: Control the first electronic element 330 according to the second enable signal EN2_L.
Step 1212: Provide the shared bus 350 for transmission of the set of operation signals to the first element 330 while both the storage element 320 and the second electronic element 340 are disabled.
Step 1214: Control the second electronic element 340 according to the third enable signal EN3_L.
Step 1216: Provide the shared bus 350 for transmission of the set of operation signals to the second element 340 while both the storage element 320 and the first electronic element 330 are disabled.

Please refer back to FIG. 3. In step 1204, the command is received and decoded by the controller 310 to generate the set of enable signals and the set of operation signals. If the storage element 320 is enabled by the first enable signal EN1_L, the shared bus 350 is provided for transmission of the set of operation signals to the storage element 320 (steps 1206-1208). At this time, both of the first electronic element 330 and the second electronic element 340 are disabled (both of the second enable signal EN2_L and the third enable signal EN3_L are set to HIGH). To reason by analogy, the shared bus 350 is provided for transmission of the set of operation signals to the first electronic element 330 if it is enabled by the second enable signal EN2_L (steps 1210-1212). At this time, both of the storage element 320 and the second electronic element 340 are disabled. Similarly, the shared bus 350 is controlled by the third enable signal EN3_L and is provided for transmission of the set of operation signals to the second electronic element 340 while both of the storage element 320 and the first electronic element 330 are disabled (steps 1214-1216).

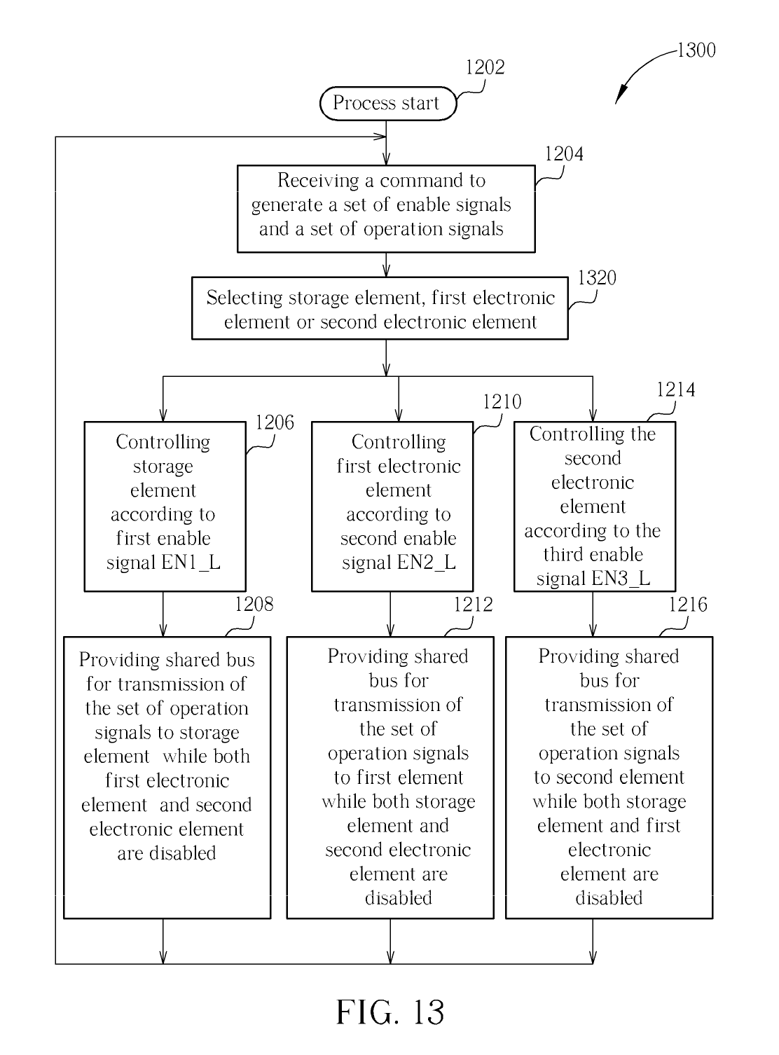

Please refer to FIG. 13, which is a flow 1300 illustrating a method for sharing a bus of an electronic system according to another embodiment of the present disclosure. The flow 1300 includes the following steps:
Step 1202: Process start.
Step 1204: Receive a command to generate a set of enable signals and a set of operation signals.
Step 1320: Select the storage element 320, the first electronic element 330, or the second electronic element 340.
Step 1206: Control the storage element 320 according to the first enable signal EN1_L.
Step 1208: Provide the shared bus 350 for transmission of the set of operation signals to the storage element 320 while both the first electronic element 330 and the second electronic element 340 are disabled.
Step 1210: Control the first electronic element 330 according to the second enable signal EN2_L.
Step 1212: Provide the shared bus 350 for transmission of the set of operation signals to the first element 330 while both the storage element 320 and the second electronic element 340 are disabled.
Step 1214: Control the second electronic element 340 according to the third enable signal EN3_L.
Step 1216: Provide the shared bus 350 for transmission of the set of operation signals to the second element 340 while both the storage element 320 and the first electronic element 330 are disabled.

The flow 1300 is similar to the flow 1200 in FIG. 12. The difference between them is that the flow 1300 further includes the step 1320. Please also refer to FIG. 11. If the electronic system 1100 includes a plurality of electronic elements, the selector 1170 can be applied to choose one of them for transmission the set of operation signals.

The abovementioned embodiments are presented merely for describing the present disclosure, and in no way should be considered to be limitations of the scope of the present disclosure. The abovementioned electronic systems are not limited to share the shared bus for the first electronic element and the second electronic element only, the shared bus can be provided for any number of electronic elements. The first electronic element and the second electronic element are not limited to a flash, an ATA, a GPIO device only, and can be other devices. Besides, the storage element is not limited to a DRAM only, and can be memory in other types. The selector is not restricted to a multiplexer only, and other elements may also be adopted. Please note that the selector is an optional device, which is not necessary and should not limit practical applications of the present disclosure.

In summary, the present disclosure provides an electronic system and related method with time-sharing bus. Through utilizing a set of enable signals to control the storage elements and a plurality of electronic elements, the shared bus (including the address bus and the data bus) can be provided for transmission of the set of operation signals to different devices at different times. The advantage of the present disclosure is that the size of the chip gets smaller due to some electronic elements being able to share the same bus (the same pin). Therefore, the cost is reduced, making the electronic system more economical to manufacture.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A electronic system with time-sharing bus, the electronic system comprising:
a controller used for receiving a command to generate a set of enable signals and a set of operation signals;
a storage element having a first set of input ends coupled to the controller for receiving a first enable signal of the set of enable signals;
a first electronic element having a first input end coupled to the controller for receiving a second enable signal of the set of enable signals; and
a shared bus coupled between the controller and the storage element, and coupled between the controller and the first electronic element;
wherein the shared bus provides the set of operation signals to the storage element while the first electronic element is disabled;
wherein the shared bus provides the set of operation signals to the first electronic element while the storage element is disabled.

2. The electronic system of claim 1, wherein the storage element is a dynamic random access memory (DRAM).

3. The electronic system of claim 2, wherein the set of enable signals comprise a clock signal, a clock enable signal, a chip select signal, or a data mask signal.

4. The electronic system of claim 2, wherein the shared bus comprises a data bus.

5. The electronic system of claim 2, wherein the shared bus comprises an address bus.

6. The electronic system of claim 1, wherein the first electronic element comprises a flash, an ATA, or a GPIO (General Purpose Input Output) device.

7. The electronic system of claim 1 further comprising:
a second electronic element having a first input end coupled to the controller for receiving a third enable signal of the set of enable signals;
wherein the shared bus is coupled between the controller and the storage, between the controller and the first electronic element, and between the controller and the second electronic element;
wherein the shared bus provides the set of operation signals to the storage element while both the first electronic element and the second electronic element are disabled;
wherein the shared bus provides the set of operation signals to the first electronic element while both the storage element and the second electronic element are disabled;
wherein the shared bus provides the set of operation signals to the second electronic element while both the storage element and the first electronic element are disabled.

8. The electronic system of claim 7 further comprising:
a selector having an input end coupled to the controller and a set of output ends coupled to the first electronic element and the second electronic element, the selector used for selecting the first electronic element or the second electronic element.

9. The electronic system of claim 1, wherein the electronic system comprises an application specific integrated circuit (ASIC).

10. A method for sharing a bus of an electronic system, the method comprising:
receiving a command to generate a set of enable signals and a set of operation signals;
controlling a storage element according to a first enable signal of the set of enable signals;
controlling a first electronic element according to a second enable signal of the set of enable signals; and
providing a shared bus for transmission of the set of operation signals to the first electronic element while the storage element is disabled.

11. The method of claim 10 further comprising:
providing the sharing bus for transmission of the set of operations signals to the storage element while the first electronic element is disabled.

12. The method of claim 10, wherein the storage element is a dynamic random access memory (DRAM).

13. The method of claim 12, wherein the set of enable signals comprise a clock signal, a clock enable signal, a chip select signal, or a data mask signal.

14. The method of claim 10, wherein the step of providing the shared bus for transmission of the set of operation signals to the first electronic element while the storage element is disabled comprises providing a data bus of a memory for the first electronic element while the storage element is disabled.

15. The method of claim 10, wherein the step of providing the shared bus for transmission of the set of operation signals to the first electronic element while the storage element is disabled comprises providing an address bus of a memory for the first electronic element while the storage element is disabled.

16. The method of claim 10, wherein the first electronic element comprises a flash, an ATA, or a GPIO (General Purpose Input Output) device.

17. The method of claim 10 further comprising:
controlling a second electronic element according to the set of enable signals;
providing the shared bus for transmission of the set of operation signals to the storage element while both the first electronic element and the second electronic element are disabled;
providing the shared bus for transmission of the set of operation signals to the first electronic element while both the storage element and the second electronic element are disabled; and
providing the shared bus for transmission of the set of operation signals to the second electronic element while both the storage element and the first electronic element are disabled.

18. The method of claim 17 further comprising:
selecting the first electronic element or the second electronic element.

19. The method of claim 10, wherein the electronic system comprises an application specific integrated circuit (ASIC).
